(19) United States
(12) Patent Application Publication
(10) Pub. No.: US 2003/0212794 A1
(43) Pub. Date: Nov. 13, 2003

(54) Network address resolution

(75) Inventors: Samy Touati, Rosemere (CA); Xiaobo Fan, Montreal (CA); Payam Etminani, Brossard (CA)

Correspondence Address: ALEX NICOLAESCU, Ericsson Canada Inc., Patent Department (LMC/UP), 8400 Decarie Blvd., Town Mount Royal, QC, H4P 2N2, CA

(73) Assignee: Telefonaktiebolaget L M Ericsson (publ)

(21) Appl. No.: 10/142,895

(22) Filed: May 13, 2002

(51) Int. Cl. G06F 15/173

(52) U.S. Cl. 709/226; 709/230

(57) ABSTRACT

A method and a node for associating an IP address of a device with its MAC address, where the network parts of the device and the node are different. The device receives an ARP response comprising the device's IP address and MAC address, accepts the response regardless of a difference between the network parts, and associates the IP address with the MAC address. There is further a method and a node in an IP network where the node receives a message for the device, determines that it does not have the MAC address corresponding to the IP address, and broadcasts an ARP request. The method and node is particularly useful for mobile IP, where a device roams between various sub-nets.

### BACKGROUND OF THE INVENTION

1. Field of the Invention

The present invention relates generally to Internet Protocol (IP) networks, and in particular to network address resolution for mobile nodes in these networks.

2. Description of the Related Art

The standard for Internet Protocol (IP) networks is to build small local networks, sub-nets, that may be joined together to form bigger networks, which in turn may be connected to the Internet or other big networks. The sub-nets are networks in which it is possible to broadcast a message, i.e. send the message to all the devices connected to the sub-net. Messages can easily be sent from one device to another over the sub-net. If a message is directed to a device that is not on the sub-net, then an intermediate device, such as a router, takes the message and sends it towards the recipient over one of the at least one other networks it is connected to. It can easily be appreciated that it is wise to keep the sub-nets relatively small as they otherwise would be choked with messages and communication would be impossible.

In IP networks, as in any network, there must be a way of directing a message towards the recipient, which is why all connected devices normally have at least two addresses: a Media Access Control (MAC) address and an Internet Protocol (IP) address.

The MAC address is unique to each device, but a device may have more than one MAC address. It is usually configured in the hardware of a network access card or similar in the device, and is used for communication on a sub-net.

The IP addresses are not hardwired in the same way as MAC address, rather they are normally assigned by some entity and the assignation is stored in one or more memories, one of which is usually located on the device itself. The assignation of an IP address may change from one device to another.

Internet users usually address messages using an alias, such as user1 @network1.com. This address does not however mean much to the most networks, which is why a network will consult a Domain Name System (DNS) server to find out the IP address corresponding to user1 in network1.com, after which it sends the message towards the received IP address.

Network1 will then route the message towards the proper sub-net. For transmission over the sub-net, however, the IP address cannot be used; only a MAC address can be used to direct the message. (This holds true for the transmission up to this point too.) The router that receives the message for direct delivery to the device has the IP address of the recipient, but needs to know the MAC address. In some cases, the router has a translation table where it can find the MAC address corresponding to an IP address, but in other cases the router does not (yet) know the MAC address. A solution is the Address Resolution Protocol (ARP) that basically allows the router to broadcast: ‘Who has the MAC address for this IP address?’ Since all devices on the sub-net hear the ARP request, the proper device will receive it, if it is connected at the moment. Devices do not know should disregard this message and the device or devices that know respond with a: ‘The MAC address for that IP address is . . . ’ In more detail, the response comprises the MAC address and the IP address of both the sender and the recipient.

The description so far has mainly been concerned with static devices that may switch on and off, but not move easily, and moving a static device often takes some work, e.g. updating router tables or changing the IP address of the device. For mobile nodes, what has been said above is not sufficient; there must be some way to know how to contact a mobile node. A solution to this problem is to have a kind of anchor, such as a Home Agent (HA), that keeps track of where the mobile node is at the moment. Other nodes may then e.g. send messages to the HA that forwards them towards the mobile device.

There must still be a way for the router on the same sub-net as the device, be it wireless or wire-line, to map the MAC address and the IP address. From certain points of view, this problem has not had any acceptable solution. It is granted that some of the solutions, such as the one provided in cdma2000, work well, but often it is at the price of a certain complexity, such as complex connection negotiations, which may not be desired in a network.

FIG. 1 is a block chart of an exemplary IP network environment illustrating how a mobile node accesses the network and how the MAC address can be made known to the sub-net. The IP network environment 100 comprises a Wireless Service Node (WSN) 130 that interfaces a sub-net 110 and the rest of the network 120. The sub-net comprises a mobile node (MN) 112 and an access point (AP) 114. The rest of the network 120 comprises an Authentication, Authorization, and Accounting (AAA) server 124, a Home Agent (HA) 126, a destination node (DN) 128, and the Internet 122 that interconnects the three nodes and the WSN 130. The WSN 130 acts as a router between nodes on the two networks 110 120 and can as such be said to be part of both networks 110 120. The MN 112 has a MAC address 115 and an IP address 113 comprising a network part, ‘netw1’, and a device part, ‘device1’. Similarly, the WSN 130 has an IP address 131 associated with its sub-net 110 side, the IP address comprising a network part, ‘netw2’, and a device part, ‘device2’. Since the MN 112 is mobile, the network part of its IP address 113 usually, as e.g. in the example, differs from the network part of the IP address 131 belonging to the WSN 130.

Within the sub-net 110 the WSN 130 broadcasts it services through the APs 114 (of which only one is shown) that relays the message as radio signals. The message is basically: ‘Talk to me if you want network access,’ and comprises, apart from the broadcast address, the IP address 131 and MAC address (not shown) of the WSN 130.

If the MN 112 wants to contact the DN 128, it sends a registration message (as specified in e.g. RFC 2002) to the AP 114 that relays the message to the WSN 130. This message comprises the IP address 113 and the MAC address 115 of the MN 112, the IP address of HA 126 and the MAC address of the WSN 130. Upon reception of the message, the WSN 130 extracts the IP address 113 and MAC address 115 of the MN 112, verifies if they are already known, and stores these in a mapping table 132 if they are not already known. This has to be done for every message received by the WSN 130 from the sub-net 110. This is because there is no other known way of obtaining the MAC address and because there is no way for the WSN 130 to know what messages are relevant or not.

If the WSN 130 stored the IP address and the MAC address, then that means that the MN 112 is not known to the WSN 130 and that the WSN 130 should check whether the MN 112 is authorized to access the network. The WSN 130 therefore sends an inquiry message to the AAA 124, which authorizes the MN 112 and responds to the WSN 130. If the MN 112 is authorized, then the WSN 130 sends a message to the HA 126 to inform it that the MN 112 currently is taken care of by the WSN 130 and that any traffic intended for the MN 112 should be sent to the WSN 130 for delivery to the MN 112. The HA 126 acknowledges this message from the WSN 130 that then can send the message from the MN 112 towards the DN 128, either through the HA 126 or not.

Any messages intended for the MN 112, however, usually have to be sent via the HA 126. The HA 126 then tunnels them (e.g. using the IP-in-IP protocol, RFC 2003) to the WSN 130 that extracts the IP address of the recipient (in this case the MN 112), maps the IP address 113 to a MAC address 115 using the mapping table 132, and uses the MAC address 115 to send the message to the MN 112 via the AP 114.

A problem with this solution is that the WSN 130 has to distinguish between signal messages and traffic messages at the link layer, which creates quite a burden on the WSN 130 and therefore lowers its throughput performance.

A further problem is that the WSN 130 has to extract the IP address and the MAC address from every single message it receives, check the mapping table 132 to see if there is a corresponding entry in there, and then create an entry if there is no entry. Most of the time there is an entry, but the WSN 130 still has to check each and every message, which creates quite a burden on the processing resources of the WSN 130.

It can therefore be appreciated that there is a need for a solution that provides mapping of IP address to MAC address with less unnecessary use of resources. The present invention provides such a solution in a simple, non-complex solution to the MAC/IP address-mapping problem.

### SUMMARY OF THE INVENTION

In one aspect, the present invention is a method in an IP network for mapping an Internet Protocol (IP) address of a mobile node (MN) to its Media Access Control (MAC) address. The IP network further comprises a service node (SN) with an IP address. The SN provides network access to the MN, a sub-net connects the MN and the SN, and the IP addresses of the MN and the SN have different network parts. The SN receives a message addressed to the MN, the message comprising the MN's IP address, and broadcasts an Address Resolution Protocol (ARP) message over the subnet to which the MN is connected, the ARP message requesting the MAC address corresponding to the MN's IP address. Upon reception by the SN of a response from the MN, the response comprising the MN's IP address and MAC address, the SN accepts the response, regardless of the network part of the MN's IP address, and maps the MAC address to the MN's IP address.

In a further aspect, the present invention is a service node (SN) in an IP network for mapping an Internet Protocol (IP) address of a mobile node (MN) to its Media Access Control (MAC) address. The SN has an IP address and provides network access to the MN, a sub-net connects the MN and the SN, and the IP addresses of the MN and the SN have different network parts. The SN comprises a first communication unit that receives a message addressed to the MN, the message comprising the MN's IP address; broadcasts an Address Resolution Protocol (ARP) message over the sub-net to which the MN is connected, the ARP message requesting the MAC address corresponding to the MN's IP address; and receives from the MN a response comprising the MN's IP address and MAC address. The SN further comprises a processing unit that accepts the response, regardless of the network part of the MN's IP address; and maps the MAC address to the MN's IP address.

In another aspect, the present invention is a method in an associating node in a data communications network for associating an Internet Protocol (IP) address of a device with its Media Access Control (MAC) address. The associating node has an IP address, a sub-net connects the device and the associating node, and the IP addresses of the device and the associating node have different network parts. The associating node receives from the device an Address Resolution Protocol (ARP) response comprising the device's IP address and MAC address, accepts the response, regardless of the network part of the device's IP address, and associates the MAC address with the MN's IP address.

In yet another aspect, the present invention is, in a data communications network, an associating node for associating an Internet Protocol (IP) address of a device with its Media Access Control (MAC) address. The associating node has an IP address, a sub-net connects the device and the associating node, and the IP addresses of the device and the associating node have different network parts. The associating node comprises a communication unit that receives from the device an Address Resolution Protocol (ARP) response comprising the device's IP address and MAC address; and a processing unit that accepts the response, regardless of the network part of the device's IP address; and associates the MAC address with the MN's IP address.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a block chart of an exemplary prior art IP network environment illustrating how a mobile node accesses the network and how the MAC address can be made known to the sub-net; and

FIG. 2 is a block chart of an exemplary IP network illustrating how a mobile node accesses the network and how the MAC address can be made known to the subnet according to the invention.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

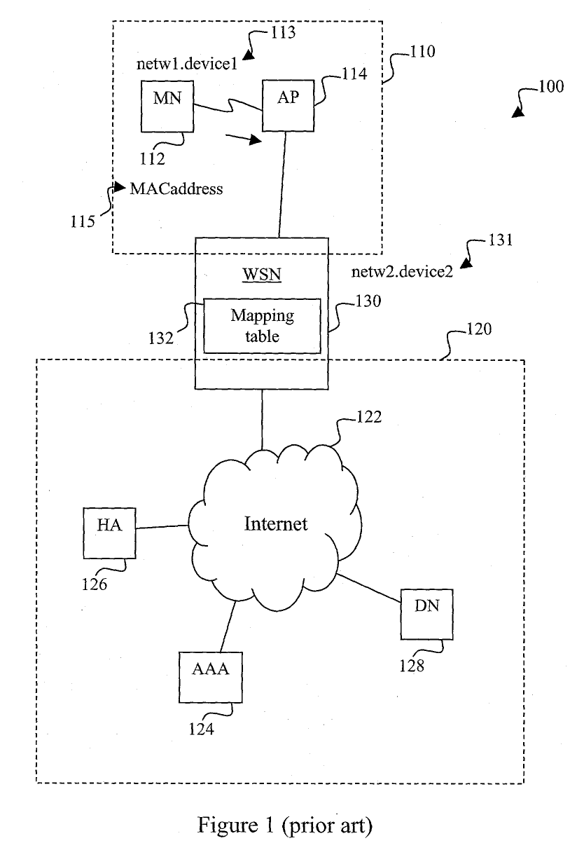

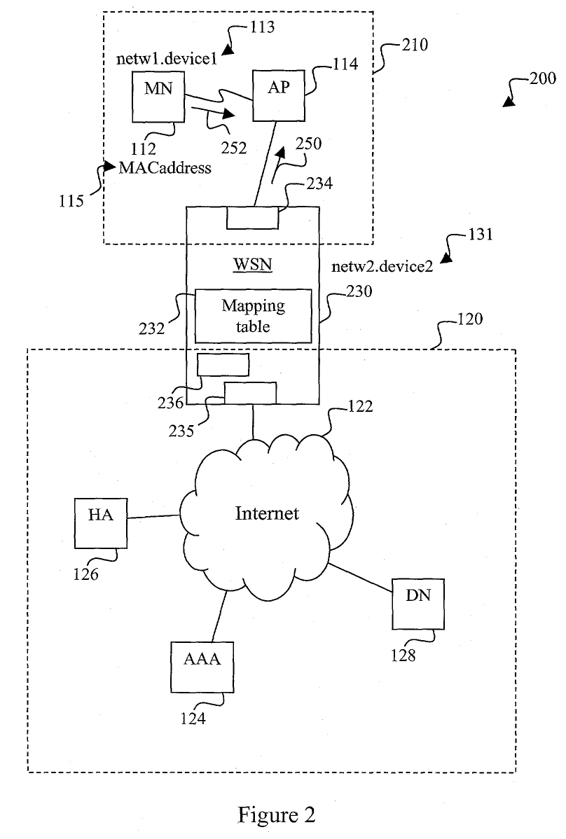

Referring now to the figures, wherein FIG. 2 is a block chart of an exemplary IP network illustrating how a mobile node accesses the network and how the MAC address can be made known to the sub-net according to the invention. The network environment 200 is relatively similar to the network environment 100 in FIG. 1. There is a Wireless Service Node 230 that interfaces a sub-net 210 and the rest of the network 120. The sub-net comprises a mobile node (MN) 112 and an access point (AP) 114. The rest of the network 120 comprises an Authentication, Authorization, and Accounting (AAA) server 124, a Home Agent (HA) 126, a destination node (DN) 128, and the Internet 122 that interconnects the three nodes and the WSN 230. The WSN 230 acts as a router between nodes on the two networks 210 120 and can as such be said to be part of both networks 210 120, being connected to them through a first and second communication unit 234 235 respectively. The WSN 230 also comprises a processing unit 236 that among other things controls the WSN 230 and processes information. The MN 112 has a MAC address 115 and an IP address 113 comprising a network part, ‘netw1’, and a device part, ‘device1’. Similarly, the WSN 230 has an IP address 131 associated with its sub-net 210 side, the IP address comprising a network part, ‘netw2’, and a device part, ‘device2’. Since the MN 112 is mobile, the network part of its IP address 113 usually differs from the network part of the IP address 131 belonging to the WSN 230.

The WSN 230 broadcasts it services through the APs 114 and if the MN 112 wants to contact the DN 128, it sends a registration message to the AP 114 that relays the message to the WSN 130, as previously described.

Differing from FIG. 1, however, the WSN 230 does not extract the MAC address 115 of the MN 112 from the message, but it does extract the IP address 113 in order to send messages to the AAA 124 and the HA 126, as described hereinbefore. The WSN 230 also checks each message to see whether or not the MN 112 is authorized to send the message, but the burden on the processor is relatively small.

Messages intended for the MN 112 are treated in the same way as described in FIG. 1 until they reach the WSN 230. The WSN 230 realizes that it does not have an entry (or at least complete entry) for the IP address 113 of the MN 112 in the mapping table 232. In order to find out the MAC address 115 corresponding to the IP address 113 it broadcasts an ARP request 250 over the sub-net 210. The MN 112 sends a response 252, giving its MAC address 115.

According to the prior art, when the WSN 230 receives the response, it verifies whether or not the request originated on the same sub-net by checking the network part of the IP address 113 of the MN 112 and discards the response if it seemingly originated from a different sub-net, i.e. if the network parts of its own IP address 131, ‘netw2’, and the network part of the IP address 113 of the MN 112, ‘netw1’, are different, as is well known in the art. Since in most cases with mobile nodes the network address of the mobile node differs from the network address of the WSN 230 this approach is not feasible in prior art networks. However, according to the present invention, the WSN 230 relaxes the requirement that the response originate from a device with an IP address for which the network part is the same as the network part of its own IP address, and accepts the response from the MN 112. The WSN 230 is then able to map the MN's IP address 113 to the MN's MAC address 115 and create an entry in the mapping table 232.

The approach according to the invention is possible, as there are only a limited number of mobile nodes in the sub-net 210 at a given time. This means that the WSN 230 can accept these messages, regardless of origin, without getting overloaded, as would be the case on the Internet 122 side of the WSN 230.

It can therefore be seen that the present invention provides mapping between IP address and MAC address in a manner that overcomes problems of the prior art.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method in an IP network for mapping an Internet Protocol (IP) address of a mobile node (MN) to its Media Access Control (MAC) address, the IP network further comprising a service node (SN) with an IP address, the SN providing network access to the MN, wherein a sub-net connects the MN and the SN, and the IP addresses of the MN and the SN have different network parts, the method comprising the steps of:
receiving by the SN a message addressed to the MN, the message comprising the MN's IP address;
broadcasting by the SN an Address Resolution Protocol (ARP) message over the sub-net to which the MN is connected, the ARP message requesting the MAC address corresponding to the MN's IP address;
receiving by the SN from the MN a response comprising the MN's IP address and MAC address;
accepting the response, regardless of the network part of the MN's IP address; and
mapping by the SN the MAC address to the MN's IP address.

2. The method of claim 1, wherein the IP network further comprises a Home Agent (HA) for the MN, the method further comprising, prior to the step of receiving by the SN a message addressed to the MN, the message comprising the MN's IP address, the steps of:
receiving by the SN from the MN a message comprising the IP address of the HA;
sending by the SN a message to the HA, the message informing the HA that the SN provides network access to the MN; and
receiving by the SN a message tunnelled from the HA, the message being addressed to the MN, the message comprising the IP address of the MN.

3. A service node (SN) in an IP network for mapping an Internet Protocol (IP) address of a mobile node (MN) to its Media Access Control (MAC) address, the SN having an IP address, wherein the SN provides network access to the MN, a sub-net connects the MN and the SN, and the IP addresses of the MN and the SN have different network parts, the SN comprising:
a first communication unit that:
receives a message addressed to the MN, the message comprising the MN's IP address;
broadcasts an Address Resolution Protocol (ARP) message over the sub-net to which the MN is connected, the ARP message requesting the MAC address corresponding to the MN's IP address; and
receives from the MN a response comprising the MN's IP address and MAC address; and
a processing unit that:
accepts the response, regardless of the network part of the MN's IP address; and
maps the MAC address to the MN's IP address.

4. The service node (SN) of claim 3, wherein the IP network further comprises a Home Agent (HA) for the MN, wherein the first communication unit further receives from the MN a message comprising the IP address of the HA, and the SN further comprises a second communication unit that:
sends a message to the HA, the message informing the HA that the SN provides network access to the MN; and
receives a message tunnelled from the HA, the message being addressed to the MN, the message comprising the IP address of the MN.

5. A method in an associating node in a data communications network for associating an Internet Protocol (IP) address of a device with its Media Access Control (MAC) address, the associating node having an IP address, wherein a sub-net connects the device and the associating node, and the IP addresses of the device and the associating node have different network parts, the method comprising the steps of:
receiving by the associating node from the device an Address Resolution Protocol (ARP) response comprising the device's IP address and MAC address;
accepting the response, regardless of the network part of the device's IP address; and
associating by the associating node the MAC address with the MN's IP address.

6. In a data communications network, an associating node for associating an Internet Protocol (IP) address of a device with its Media Access Control (MAC) address, the associating node having an IP address, wherein a sub-net connects the device and the associating node, and the IP addresses of the device and the associating node have different network parts, the associating node comprising:
a communication unit that:
receives from the device an Address Resolution Protocol (ARP) response comprising the device's IP address and MAC address; and
a processing unit that:
accepts the response, regardless of the network part of the device's IP address; and
associates the MAC address with the MN's IP address.
